(19) United States
(12) Patent Application Publication
(10) Pub. No.: US 2017/0129795 A1
(43) Pub. Date: May 11, 2017

(54) REVERSE OSMOSIS WATER PURIFIER

(71) Applicant: Marmon Water (Singapore) Pte. Ltd., Singapore (SG)

(72) Inventor: Vivek K. N. Singh, Nagpur (IN)

(21) Appl. No.: 15/000,089

(22) Filed: Jan. 19, 2016

(30) Foreign Application Priority Data
Nov. 10, 2015 (IN) 4290/MUM/2015

(51) Int. Cl. C02F 9/00; C02F 1/44; C02F 1/00; B01D 61/02; B01D 61/12; C02F 1/28; B01D 37/04

(52) U.S. Cl. CPC C02F 9/00; C02F 1/283; C02F 1/441; B01D 37/046; B01D 61/025; B01D 61/12; C02F 1/008; B01D 37/04; C02F 2209/10; C02F 2209/03; C02F 2209/05; C02F 2101/322

(57) ABSTRACT

A reverse osmosis water purifier that monitors Total Dissolved Solids (TDS) at the onset of entering the water filtration system and downstream upon exiting the system. A comparison of the TDS levels is made to each other or predetermined levels, and action is taken regarding whether to bypass the RO filter, or continue filtering through the RO membrane, or combine the two fluid streams. A microbiological barrier filter is introduced in-line with the egress port of a reverse osmosis filter, and downstream of the bypass water circuit. The microbiological filter is utilized to remove microbiological contaminants from the output water, either directly from the RO filter output, or the bypass filter circuit, or both.

### BACKGROUND OF THE INVENTION

1. Field of the Invention

The present invention relates to a Reverse Osmosis (RO) water purifier that monitors Total Dissolved Solids (TDS), and provides a barrier for microbiological contaminants. Specifically, the present invention relates to a RO system having an input and output, Total Dissolved Solids (TDS) probes that use conductivity of the water as the monitored parameter at inlet of the device and outlet of filtration train, and a microbiological filter in the filtered water egress path.

2. Description of Related Art

Reverse Osmosis, a water treatment method traditionally known for removing salt from seawater, is also used to purify drinking water by forcing untreated water molecules through a semi-permeable membrane or filter. The membrane blocks contaminants and the impurities are subsequently expelled from the environment.

It is a process where a weaker saline solution will tend to migrate to a strong saline solution; that is, a solution that is less concentrated will have a natural tendency to migrate to a solution with a higher concentration. Reverse osmosis occurs when the solution is moved across a membrane against the concentration gradient, from lower concentration to higher concentration. For example, under normal osmosis, a semipermeable membrane with fresh water on one side and a concentrated aqueous solution on the other side would have the fresh water cross the membrane to dilute the concentrated solution. In reverse osmosis, pressure is exerted on the side with the concentrated solution to force the water molecules across the membrane to the lower concentration side.

A typical reverse osmosis water filtering system uses a semi-permeable membrane that has the ability to remove and reject a wide spectrum of impurities and contaminants from water. These contaminants are automatically rinsed down the drain. The purified water s then stored in a tank.

The predetermined pressure is applied to the incoming water to force the incoming water through the membrane. The membrane filters impurities from the incoming water leaving purified water on the other side of the membrane, which is referred to as “permeate” stream. The impurities left on the membrane are washed away by a portion of the incoming water that does not pass through the membrane. The water carrying the impurities washed away from the membrane is called “concentrate stream.”

Some of the benefits of employing a RO system include: pure, clean drinking water; removal of unwanted odors or tastes; and minimal maintenance.

In the operation of reverse osmosis systems, the input liquid is divided into two output streams—the permeate stream which is substantially free of the dissolved substance and the concentrate stream which contains the majority of the substance to be removed. Reverse osmosis systems utilize a semi-permeable membrane with the input stream being fed at a pressure substantially above the osmotic pressure of the feed solution. When it is fed across the membrane, water molecules preferentially pass through the membrane with a very limited amount of the dissolved substances also passing through the membrane, depending upon the type of membrane and operation of the system.

Reverse osmosis is utilized in water purifiers after particulate/sediment filters and chlorine removal components/devices as a secondary or tertiary water purification technology employing a semipermeable membrane to remove very small particles and dissolved substances which may include microorganisms, as well as molecules of organic compounds of natural and man-made origin, charged species of elements such as calcium (Ca), magnesium (Mg), lead (Pb), arsenic (As), as also ions such as carbonates, sulfates, chlorides, and the like, from drinking water. A semipermeable membrane is a membrane that will allow some atoms or molecules to pass but not others. Reverse osmosis can thus remove many types of molecules and ions from solutions, including microorganisms, and is used in both industrial processes and the production of potable water.

The water stream that carries the concentrated contaminants that did not pass through the RO membrane is generally referred to as the waste (reject or brine) stream.

As a consequence of an RO system, a portion of the water supply must be used to flush the contaminants to drain. Thus, there is a usage (waste) factor that can represent a significant portion of the total water use.

The use of reverse osmosis systems is well known in the art. For example, in U.S. Patent Publication No. 2004/0104157, published to Beeman, et al., on Jun. 3, 2004, titled “PURIFIED WATER SUPPLY SYSTEM,” a system is taught for providing purified water having a plurality of individual modules, each of which includes a separable head and a canister, which modules are joined one to another via these heads to create a composite manifold. The overall system is monitored by a control unit that is regularly interrogated by an off-site, headquarters' computer, and both the control unit and the headquarters' computer are proactive in detecting potential difficulties that may be able to be readily remedied by promptly dispatching a serviceperson with a replacement for the canister containing the operating unit that requires replacement. A TDS sensor is provided in the line leading to the storage tank, and it is connected to a recorder that is part of the control unit so that a record is made of the effectiveness of the RO unit to purify the water (prior to its being treated in a post filter module) over the lifetime of the RO element. However, there is no teaching of monitoring the conductivity before the water enters the RO unit, or making a comparison of the conductivity data after the water is filtered; nor is there any teaching of introducing a microbiological barrier after the RO filtration.

In U.S. Patent Publication No. 2008/0052094, published to Morfopoulos, et al., on Feb. 28, 2008, titled “WATER DISPENSING SYSTEMS AND METHODS,” a system for dispensing water having an input connected to receive water from a water supply system and an output configured to dispense a metered amount of processed water is taught. The water processing system defines a closed path between the input and the output, a control system operatively coupled to the water processing system for controlling the dispensing of processed water from the output, and a user interface operatively coupled to the control system for pet uniting a user to cause the output to dispense a desired amount of processed water. The user interface comprises control means for starting and stopping a flow of processed water from the output, and logging means for debiting the amount of process water dispensed from the output from a user account. A TDS sensor may be provided inline to control the system with a measurement of TDS. A mechanical filtration system may remove particles from the water having a size of five microns or larger. The mechanical filtration system may also remove chlorine from the water. However, the five micron size of particles removed is above most microbiologicals. Furthermore, the mechanical filtration system is before the RO filter, which means it cannot act upon the permeate.

In U.S. Patent Publication No. 2010/0292844, published to Wolf on Nov. 18, 2010, titled “SELF-CONTAINED PORTABLE MULTI-MODE WATER TREATMENT SYSTEM AND METHODS,” an automated water treatment system is taught for treating raw water to produce potable water. The system has several selectable treatment subsystems and a controller which automatically selects and controls the mode of operation from a transient, normal, or backwashing mode, automatically controls the flow of water through a treatment path based upon the selected mode of operation and the measured water quality characteristics of the water at selected locations, automatically determines, based upon the selected mode of operation and the water quality parameter measurements, which of the plurality of the selectable subsystems is needed to produce potable water at the output; and automatically direct the flow of water through a treatment path through the system to bypass the water treatment subsystems and elements that are not needed to produce potable water.

There is a TDS monitor inline. If a sufficiently high concentration of TDS is detected at a conductivity sample point, the controller provides a signal to direct activation of a suitable valve to route the partially treated water through a conduit to the reverse osmosis elements for removing the dissolved solids.

The controller can automatically use the measured water characteristics to determine the water quality at various locations throughout the treatment system, and then based upon the selected mode of operation and the measured water quality parameters, automatically select and control which of the treatment processes are needed to produce potable water.

It is noted that the system is not tested for water quality after an activated carbon filtration system; and therefore, does not consider the effects of taste at egress.

In addition to the above, it has been observed that performance efficiency of RO based water purifiers is dependent on the incoming raw water quality. Consequently, the conductivity and taste of the water at the outlet is not same if raw water quality varies.

### SUMMARY OF THE INVENTION

Bearing in mind the problems and deficiencies of the prior art, it is therefore an object of the present invention to provide a Reverse Osmosis (RO) water purifier that monitors Total Dissolved Solids (TDS), and provides a barrier for microbiological contaminants.

It is another object of the present invention to introduce a fibrous microbiological barrier in-line with the egress port of a reverse osmosis filter, and downstream of a bypass water circuit to remove microbiological contaminants from the output water.

It is yet another object of the present invention to monitor the TDS levels at an input stage of the water circuit and at an exit stage, after water has traversed through a RO filter and/or a microbiological barrier filter.

It is yet another objective of the present invention to provide microbiologically safe, potable water with a constant taste irrespective of the feed Raw Water Quality

The above and other objects, which will be apparent to those skilled in the art, are achieved in the present invention which is directed to a water filter system comprising: an inlet; an outlet in fluid communication with the inlet; a first total dissolved solids (TDS) probe positioned between the inlet and the outlet; a first junction positioned downstream of the first TDS probe, the first junction redirecting water from the first TDS probe towards a bypass fluid circuit in a first direction and a filtering fluid circuit in a second direction; the bypass fluid circuit comprising a bypass solenoid valve, and in fluid communication with a second junction; the filtering fluid circuit comprising a reverse osmosis filter, the reverse osmosis filter having a permeate outlet and a concentrate outlet, wherein the permeate outlet is in fluid communication with the bypass fluid circuit at a second junction; a microbiological barrier filter in fluid communication with the permeate outlet and the bypass fluid circuit via the second junction, positioned downstream of the second junction; a second TDS probe downstream of, and receiving filtered water from, the microbiological barrier filter; and a storage tank positioned upstream of the outlet, the storage tank storing the filtered water prior to exiting the water filter system.

A sediment filter may be positioned between the inlet and the first TDS probe.

A low pressure sensor may be placed in fluid communication with the sediment filter and positioned between the sediment filter and the first TDS probe, wherein when the low pressure sensor senses a pressure drop, open contacts close, completing an electrical circuit which can send a signal to a controller, activate a pump, or other action, and when a set pressure is reached, the contacts open.

A first solenoid valve may be placed in the filtering fluid circuit, and positioned downstream of the first junction, the first solenoid valve, when open, allowing fluid to flow to the RO filter.

A reverse osmosis pump in the filtering fluid circuit, may be positioned upstream of the RO filter, configured to apply fluid under pressure to the RO filter. Also, a carbon filter in the filtering fluid circuit is positioned upstream of the RO filter.

The system may incorporate a manual control valve in the bypass fluid circuit.

A reject fluid circuit is connected to the concentrate outlet of the RO filter for dispensing rejected water. The reject fluid circuit includes an auto flush solenoid valve.

Preferably, the microbiological barrier filter is a treated fibrillated fibered, activated carbon filter capable of removing microbiologicals and VOC's.

In a second aspect, the present invention is directed to a water filter system comprising: an inlet; a sediment filter downstream of, and in fluid communication with, the inlet; an outlet in fluid communication with the inlet; a low pressure switch in fluid communication with the sediment filter; a first total dissolved solids (TDS) probe positioned between the inlet and a first junction; the first junction positioned downstream of the first TDS probe, the first junction redirecting water from the first TDS probe towards a filtering fluid circuit in a first direction, and a bypass fluid circuit in a second direction; the filtering fluid circuit comprising: a reverse osmosis solenoid valve for regulating fluid through the filtering fluid circuit; a pump positioned upstream of a reverse osmosis filter, configured to apply fluid under pressure to the RO filter; the reverse osmosis filter having a permeate outlet and a concentrate outlet, wherein the permeate outlet is in fluid communication with the bypass fluid circuit at a second junction; a carbon filter positioned between, and in fluid communication with, the reverse osmosis pump and the reverse osmosis filter; the bypass fluid circuit comprising a bypass solenoid valve, and in fluid communication with a second junction; a microbiological barrier filter in fluid communication with the permeate outlet and the bypass fluid circuit via the second junction, positioned downstream of the second junction; a second TDS probe downstream of, and receiving filtered water from, the microbiological barrier filter; a storage tank positioned upstream of the outlet, the storage tank storing the filtered water prior to exiting the water filter system; and a reject water fluid circuit in fluid communication with the concentrate outlet for disposing rejected water from the reverse osmosis filter.

In a third aspect, the present invention is directed to a method of purifying water in a reverse osmosis system comprising: passing fluid through a sediment filter; empirically determining, a first total dissolved solids level; filtering the fluid through a first junction to either a filtering fluid circuit or a bypass fluid circuit; the filtering fluid circuit including a carbon filter, a reverse osmosis pump, and a reverse osmosis filter, wherein the reverse osmosis filter includes a permeate output in fluid communication with a second junction, and a concentrate output; the bypass fluid circuit including a bypass solenoid valve in fluid communication with the second junction; filtering fluid from the permeate output through a microbiological barrier fluid; empirically determining a second total dissolved solids level; comparing the first and second total dissolved solids level; and redirecting fluid into the filtering fluid circuit or the bypass fluid circuit depending upon a predetermined level of the first or second total dissolved solids level, or both total dissolved solids levels.

The method includes storing filtered fluid in a storage tank after measuring the second total dissolved solids level; directing fluid from the concentrate output to a reject fluid circuit in fluid communication with a drain; providing a manual flow control valve in the bypass fluid circuit; and operating the manual control valve based upon the predetermined level of the first or second total dissolved solids level, or both total dissolved solids levels.

Fluid pressure may be monitored upstream of the first junction.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 depicts a schematic of the water flow of the RO system of the present invention.

### DESCRIPTION OF THE PREFERRED EMBODIMENT(S)

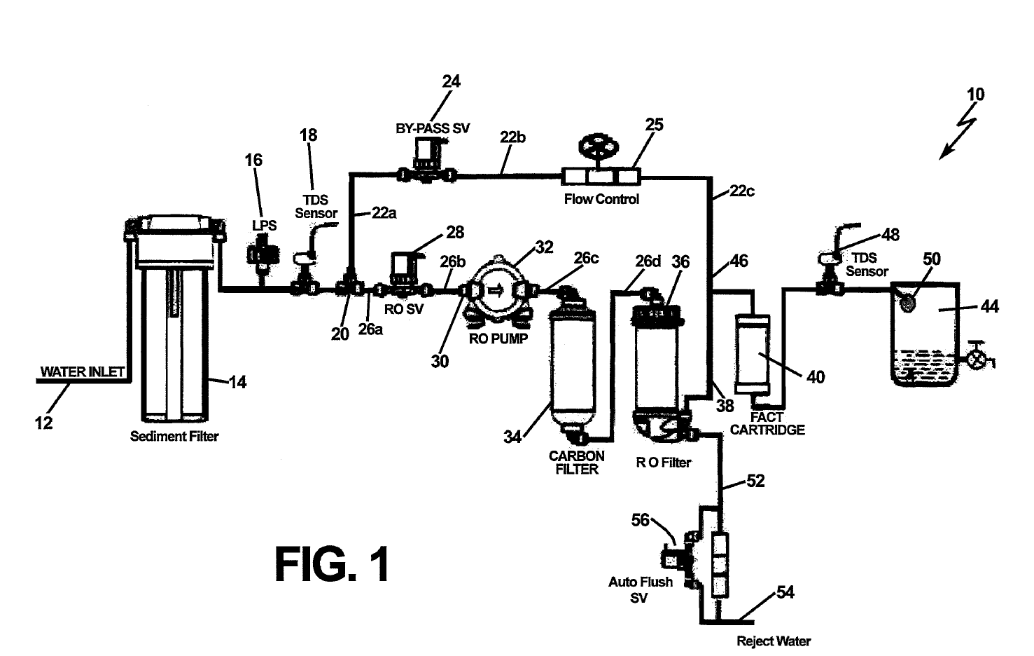

In describing the preferred embodiment of the present invention, reference will be made herein to FIG. 1 of the drawings in which like numerals refer to like features of the invention.

The present invention introduces a reverse osmosis system that includes at least dual monitoring of total dissolved solids using a comparison measurement of input and output TDS probes to ensure the supply of uniformly tasting, safe drinking water irrespective of the feed water quality, which is generally difficult to produce from a RO system. The TDS probes ensure a constant supply of water with extremely low variance in conductivity and taste, and irrespective of high and variable dissolved solids content in input water.

Total Dissolved Solids (TDS) are the total amount of mobile charged ions, including minerals, salts or metals dissolved in a given volume of water, expressed in units of mg per unit volume of water (mg/L), also referred to as parts per million (ppm). TDS is directly related to the purity of water and the quality of water purification systems and affects everything that consumes, lives in, or uses water, whether organic or inorganic, whether for better or for worse.

Some dissolved solids come from organic sources such as leaves, silt, plankton, and industrial waste and sewage. Other sources come from runoff from urban areas, road salts used on street during the winter, and fertilizers and pesticides used on lawns and farms.

Dissolved solids also come from inorganic materials such as rocks and air that may contain calcium bicarbonate, nitrogen, iron phosphorous, sulfur, and other minerals. Many of these materials form salts, which are compounds that contain both a metal and a nonmetal. Water may also pick up metals such as lead or copper as they travel through pipes used to distribute water to consumers.

A TDS meter is an excellent tool for determining the efficacy of many types of water filtration and purification systems.

Electrical conductivity of water is directly related to the concentration of dissolved ionized solids in the water. Ions from the dissolved solids in water create the ability for that water to conduct an electric current. TDS meters, also known as TDS testers or indicators, are digital or analog meters that measure the electrical conductivity of water. Based on that conductivity, the meters estimate what the true TDS level might be.

Generally, the relationship of TDS and specific conductance of groundwater can be approximated by the following equation:

TDS=kₑEC
where
   TDS is the total dissolved solids (mg/L); and
   EC is the electrical conductivity (microsiemens per centimeter at 25° C.).

The correlation factor kₑ varies between 0.50 and 1.0; that is, the total dissolved solids in ppm usually ranges from 0.5 to 1.0 times the electrical conductivity.

FIG. 1 depicts a schematic of the water flow of the RO system 10 of the present invention. As depicted, water feeds into the water purification system via a water inlet 12. It passes through a sediment filter 14. Sediment is any particulate matter that can be transported by fluid flow and which eventually is deposited as a layer of solid particles on the bed or bottom of a body of water or other liquid. Well water and older public water systems sometimes contain sand, iron, silt and other forms of sediment. A sediment filter acts as a sieve to remove this particulate matter.

Next in the fluid stream is a low pressure switch (LPS) 16. There are a number of low pressure switches on the market. In preferred instances, the switch is passive, requiring no manual operation—water pressure does it all. When the pressure drops, the normally open contacts close, completing an electrical circuit which can send a signal to a controller, activate a pump, or other action. When the set pressure is reached, the contacts open again, sending another signal.

In other instances, LPS's in the water line work with a diaphragm pressing against a piston and spring inside the unit. The spring pressure is set by an adjustment screw. Sufficient pressure on the diaphragm keeps the switch “off” When the pressure drops, the switch activates.

In the present case, if the pressure is high enough to activate the switch the water will flow though to a first inline TDS probe or sensor 18.

As noted previously, TDS probe 18 measures the conductance of the water and sends a signal to a control unit (not shown) of the system 10 which processes the signal and may indicate the resultant level on a display panel of the device, such as an LED display. This also alerts the user to instances when the TDS is very high or very low. If the TDS level is very low the RO system may not be needed in which case the device may operate without power. Water flowing from the TDS probe enters a “T” junction 20 having a first connection to a bypass fluid circuit 22a,b,c commencing with a bypass feed line 22a, wherein a normally closed bypass solenoid valve 24 operates to allow or deny water flow, and a second connection to a filtering fluid circuit 26a,b,c,d starting with a filtering feed line 26a to a RO solenoid valve 28, which leads to the inlet 30 via feed line 26b to RO pump 32. If the pressure is high enough, RO pump 32 pumps water through feed line 26c to an inline carbon filter 34 connected in series by feed line 26d to a RO filter 36. RO solenoid valve 28 is capable of closing the RO fluid circuit upon activation.

At times for convenience of assembly and operation, the sediment filter (14) and carbon filter (34) can be combined to make a composite Filter that those skilled in the art shall understand. In which case the same can be placed either before or after low pressure switch (LPS) 16.

The resulting output permeate 38 is sent to a storage tank 44 via a microbiological barrier filter 40. Preferably, this microbiological barrier filter 40 is a FACT® filter cartridge of K.K. Technologies, LLC of West Haven, Conn. KX Technologies' FACT® media is made using various adsorbents immobilized by fibrillated microfilters. The media is produced in a wet laid process yielding an extremely uniform media, where high percentages of very small adsorbents can be immobilized down to 1 micron average particle size efficiently.

Fibrillated fibers allow immobilization of a wide range of particle types and sizes. The smallest particles that can be immobilized are approximately 1 micron average particle size. The upper limit is as large as 500 microns. Using smaller particles allows a lower total weight of media with the significant contaminant reductions.

The FACT® fibers are chemically treated for microbiological filtration. The small pore size coupled with the microbiological chemistry and large pore area allows for low pressure drop and high activity. These filters are constructed to flow under gravity or pressurized conditions. They are designed to remove residual microorganisms and associated residue leaking from the RO membrane. Another TDS sensor monitors the filtered water exiting the system.

A microbiological barrier comprised of treated, fibrillated fibers, such as FACT® fibers, ensures complete removal of residual odor, VOC's, pyrogens, and residual microbes that escape the RO membrane. In contrast, many prior art devices use either UV Light or an ultrafiltration (UF) membrane or the two together to achieve safe drinking water in a RO bypass stream.

The microbiological barrier filter 40 is situated on the resultant output permeate stream line 38.

Microbiological barrier filter 40 is preceded by a “T-junction” 46 and followed by an outlet TDS probe or sensor 48. T-junction 46 has two inlet connections—one being the resultant output permeate stream line 38, and the other being the output of bypass line 22, which commences at T-junction 20, through bypass solenoid valve 24 and manual flow control valve 25. If TDS probe 48 detects the TDS to be below a certain predetermined limit, then a signal is sent to open the bypass solenoid valve 24 and receive water at a higher TDS. At the occurrence of this signal, RO Pump 32 and RO safety valve 28 are shut off simultaneously. The bypassed water is then mixed with permeate water in the housing of the microbiological barrier filter 40. Contrary to the prior art, introducing a microbiological barrier filter (preferably with FACT® media) downstream of the RO filter and downstream of the bypass stream line, enables the microbiological barrier filter to receive bypass water, and ensure removal of bacteria, virus and cysts in the bypassed water.

TDS is measured in TDS probe 48 en-route storage tank 44. Bypass solenoid valve 24 is open as long as the desired TDS is achieved at TDS probe 48. If the TDS level at TDS probe 48 exceeds the desired, predetermined level, then TDS probe 48 signals for bypass solenoid valve 24 to be shut-off, while simultaneously signaling for RO safety valve 28 to be opened, and RO pump 32 to be activated.

The entire bypass system circuit may be overridden by manual flow control valve 25 downstream bypass solenoid valve 24 and before T-junction 46. Manual flow control valve 25 may be activated to shut down the bypass system circuit if the measured TDS level exceeds a predetermined upper limit, for example greater than 500 mg/l.

Reject water from RO filter 36 is directed via fluid conduit 52 to a waste water port 54. An auto-flush solenoid valve 56 may be placed in the fluid circuit to remove reject water in the concentrate stream from RO filter 36.

In the event of power being off (i.e., the RO pump unable to operate), the normally closed bypass solenoid valve 24 defaults to an open state, allowing the water to flow from sediment filter 14 through the microbiological barrier filter 40, and finally to storage tank 44. Storage tank 44 is preferably fitted with float valve-switch 50 to ensure that the water flow is mechanically shut-off and power supply to RO are cut-off when the tank is full.

The present invention provides a reverse osmosis water purifier that monitors Total Dissolved Solids (TDS) at the onset of entering the water filtration system and downstream upon exiting the system. A comparison of the TDS levels is made, and action is taken regarding whether to bypass the RO filter, or continue filtering through the RO membrane. A microbiological harrier filter is introduced in-line with the egress port of a reverse osmosis filter, and downstream of the bypass water circuit. The microbiological filter is utilized to remove microbiological contaminants from the output water, either directly from the RO filter output, or the bypass filter circuit, or both.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A water filter system comprising:
an inlet;
an outlet in fluid communication with said inlet;
a first total dissolved solids (TDS) probe positioned between said inlet and said outlet;
a first junction positioned downstream of said first TDS probe, said first junction redirecting water from said first TDS probe towards a bypass fluid circuit in a first direction and a filtering fluid circuit in a second direction;
said bypass fluid circuit comprising a bypass solenoid valve, and in fluid communication with a second junction;
said filtering fluid circuit comprising a reverse osmosis filter, said reverse osmosis filter having a permeate outlet and a concentrate outlet, wherein said permeate outlet is in fluid communication with said bypass fluid circuit at a second junction;
a microbiological barrier filter in fluid communication with said permeate outlet and said bypass fluid circuit via said second junction, positioned downstream of said second junction;
a second TDS probe downstream of, and receiving filtered water from, said microbiological barrier filter; and
a storage tank positioned upstream of said outlet, said storage tank storing said filtered water prior to exiting said water filter system.

2. The water filter system of claim 1 including a sediment filter positioned between said inlet and said first TDS probe.

3. The water filter system of claim 2 including a low pressure sensor in fluid communication with said sediment filter and positioned between said sediment filter and said first TDS probe, wherein when said low pressure sensor senses a pressure drop, open contacts close, completing an electrical circuit which can send a signal to a controller, activate a pump, or other action, and when a set pressure is reached, said contacts open.

4. The water filter system of claim 1 including a first solenoid valve in said filtering fluid circuit, and positioned downstream of said first junction, said first solenoid valve, when open, allowing fluid to flow to said RO filter.

5. The water filter system of claim 1 including a RO pump in said filtering fluid circuit, positioned upstream of said. RO filter, configured to apply fluid under pressure to said RO filter.

6. The water filter system of claim 1 including a carbon filter in said filtering fluid circuit positioned upstream of said RO filter.

7. The water filter system of claim 1 including a manual control valve in said bypass fluid circuit.

8. The water filter system of claim 1 including a reject fluid circuit connected to said concentrate outlet of said RO filter for dispensing rejected water.

9. The water filter system of claim 8 wherein said reject fluid circuit includes an auto flush solenoid valve.

10. The water filter system of claim 1 wherein said microbiological barrier filter is a treated fibrillated fibered, activated carbon filter capable of removing microbiologicals and VOC's.

11. A water filter system comprising:
an inlet;
a sediment filter downstream of, and in fluid communication with, said inlet;
an outlet in fluid communication with said inlet;
a low pressure switch in fluid communication with said sediment filter;
a first total dissolved solids (TDS) probe positioned between said inlet and a first junction;
said first junction positioned downstream of said first TDS probe, said first junction redirecting water from said first TDS probe towards a filtering fluid circuit in a first direction, and a bypass fluid circuit in a second direction;
said filtering fluid circuit comprising:
a reverse osmosis solenoid valve for regulating fluid through said filtering fluid circuit;
a pump positioned upstream of a reverse osmosis filter, configured to apply fluid under pressure to said RO filter;
said reverse osmosis filter having a permeate outlet and a concentrate outlet, wherein said permeate outlet is in fluid communication with said bypass fluid circuit at a second junction;
a carbon filter positioned between, and in fluid communication with, said reverse osmosis pump and said reverse osmosis filter;
said bypass fluid circuit comprising a bypass solenoid valve, and in fluid communication with a second junction;
a microbiological barrier filter in fluid communication with said permeate outlet and said bypass fluid circuit via said second junction, positioned downstream of said second junction;
a second TDS probe downstream of, and receiving filtered water from, said microbiological barrier filter;
a storage tank positioned upstream of said outlet, said storage tank storing said filtered water prior to exiting said water filter system; and
a reject water fluid circuit in fluid communication with said concentrate outlet for disposing rejected water from said reverse osmosis filter.

12. A method of purifying water in a reverse osmosis system comprising:
passing fluid through a sediment filter;
empirically determining a first total dissolved solids level;
filtering said fluid through a first junction to either a filtering fluid circuit or a bypass fluid circuit;
said filtering fluid circuit including a carbon filter, a reverse osmosis pump, and a reverse osmosis filter, wherein said reverse osmosis filter includes a permeate output in fluid communication with a second junction, and a concentrate output;
said bypass fluid circuit including a bypass solenoid valve in fluid communication with said second junction;
filtering fluid from said permeate output through a microbiological barrier fluid;
empirically determining a second total dissolved solids level;
comparing said first and second total dissolved solids level; and
redirecting fluid into said filtering fluid circuit or said bypass fluid circuit depending upon a predetermined level of said first or second total dissolved solids level, or both total dissolved solids levels.

13. The method of claim 12 including storing filtered fluid in a storage tank after measuring said second total dissolved solids level.

14. The method of claim 12 including directed fluid from said concentrate output to a reject fluid circuit in fluid communication with a drain.

15. The method of claim 12 including providing a manual flow control valve in said bypass fluid circuit, and operating said manual control valve based upon said predetermined level of said first or second total dissolved solids level, or both total dissolved solids levels.

16. The method of claim 12 including monitoring fluid pressure upstream of said first junction.

17. The method of claim 14 including providing an auto flush solenoid valve in said reject fluid circuit.
